(19) United States
(12) Patent Application Publication
(10) Pub. No.: US 2006/0263550 A1
(43) Pub. Date: Nov. 23, 2006

(54) Print receptive topcoat for ink jet printing media

(76) Inventors: Charles Nichols, Terre Haute, IN (US); Kathleen Laurenzo, Terre Haute, IN (US); Michael Bradshaw, Eastlake, OH (US); Adrian DeKrom, Newbury, OH (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/299,490

(22) Filed: Dec. 12, 2005

Related U.S. Application Data
(60) Provisional application No. 60/634,847, filed on Dec. 10, 2004.

(51) Int. Cl. B41M 5/40

(52) U.S. Cl. 428/32.34

(57) ABSTRACT

An ink jet media ink receptive topcoat composition of a number of constituent components including a binder comprised of polydextrose and/or indigestible polysaccharide or combination thereof, wherein a topcoat derived from the coating composition is printable with either pigment or dye composition ink jet printing inks. The invention also relates to ink jet media with a base support layer and a media coating composition, or ink receptive topcoat which includes a polydextrose and/or indigestible dextrin binder wherein the topcoat is printable with liquid ink jet inks. The invention results in improved print quality, significantly improved print color (Chroma) development, and a lower cost coating when compared to like media employing a coating containing polyvinyl alcohol or polyvinylpyrrolidone as a binder.

### FIELD OF THE INVENTION

The present invention relates to an ink-receptive topcoat for ink jet printing media. More particularly, the invention relates to an ink-receptive topcoat for ink jet printing media, which utilizes polydextrose, an indigestible polysaccharide or dextrinized oligosaccharide or combination thereof as a binder.

### BACKGROUND OF THE INVENTION

The relatively low cost and convenient use of ink jet printers make such printers the generally preferred devices for recording processed images. Ink jet printing technology is usually broken down into two categories: continuous flow and drop-on-demand printing (including thermal and piezoelectric systems). In a typical ink jet printing or recording system, ink droplets are ejected from a nozzle at high speed in a controlled manner to come in contact with a recording media to produce a printed image on the media surface. The ink droplets, or recording liquid, are generally comprised of a recording agent, such as a dye or pigment, and a significant amount of a carrier liquid component. The carrier liquid is typically water and an organic solvent such as a monohydric alcohol, a polyhydric alcohol or mixtures thereof.

Ink jet recording media is typically composed of a base support layer having on at least one surface thereof an ink-receiving or image-receiving coating. Ink jet media types include those intended for reflection viewing, which have an opaque support layer such as a paper or pigmented film, and those intended for viewing by transmitted light, which have a transparent film support layer.

Ink jet media are typically used in both Narrow Format and Wide Format ink jet imaging devices or printers. Ink jet media is typically used to produce a wide variety of printed materials. Narrow Format, or Home/Office printed applications include, but are not limited to, newsletters, reports, brochures, catalog sheets, mailing labels, inventory control documents, tags, invitations, greeting cards etc. Wide Format, or business to business (B2B), printed applications include, but are not limited to, maps, billboards, vehicle graphics, banners, posters, and signs.

The acceptability of recorded images produced with ink jet printers is in many cases highly dependent on the recording medium. How well the media prints is almost entirely dependent on the quality of the topcoat applied. Key among the concerns of ink jet recording media are the requirement of the ink/media to dry quickly after the ink jet printing process and the ability to control both the absorption, and spread of the ink to provide an acceptable level of print color development and image quality.

One primary purpose of an ink jet media topcoat is to effectively absorb the liquid solvent, or carrier component of the ink jet ink, while providing sufficient “hold out” properties which allow the solid pigment or dye component of the ink jet ink to remain concentrated near the coated surface and effectively produce an acceptable quality printed image. The topcoat provides a base to which the ink can adhere. Without this coating, the inks would run, flake off or not dry.

Ink jet media topcoats control dry time of the ink by interacting with the chemistry of the ink. The topcoats also regulate drop spread. That is, the ink drop needs to maintain a certain circumference at its base. Topcoats prevent the ink drop from spreading and flattening. The topcoat also controls how far the ink drop is saturated into the media, ensuring that the ink saturates only to a certain point. Without a coating, many media such as paper would experience bleed through. The topcoat prevents ink from saturating these products and soaking through to the opposite side. Importantly, topcoats improve image definition. A smooth coating that controls saturation, bleed-through, spread and height of the drop will result in good image definition and image clarity.

Topcoat options include swellable, porous, and hybrid topcoats. Porous topcoats are quick drying, provided they are of sufficient thickness and possess sufficient pore volume to effectively contain and control the liquid ink. A porous recording media coating can be manufactured containing, a particulate (filler), a binder and a solvent, or carrier.

Particulate-containing topcoats are applied to a media support layer and subsequently dried bonding them to the media base. The particles are often silica, but other materials including calcium carbonate and kaolin are used. The solvent or carrier can be either water or an alcohol.

Typical solvents or carriers include de-ionized water, alcohol (monohydric or polyhydric) or a combination thereof. Choice of the carrier, solvent type and composition can affect the absorption and drying characteristics of the topcoat during application to the base media sheet.

A polymeric binder that is compatible with the aforementioned components is used to bind the particles to the paper. The binder helps the absorption of the carrier liquid of the ink. The binder material imparts to the base (receiver) sheet improvements in optical density and coating adhesion to the substrate, reduced chalking of the applied topcoat, and greater paper-like texture of the coated base sheet. Additionally, improved ink water-fastness, improved uniformity of solid area printed colors, reduced bi-directional color banding in mixed primary colors and reduced inter-color mixing of adjacent printed colors result. The binder also serves the function of holding the pigment so as to reduce or eliminate dusting or chalking of the ink which results in clogging of the very fine orifice nozzles of ink jet printers.

The binder can be a hydrophilic polymer such as polyvinyl alcohol, polyvinyl pyrrolidone, gelatin, cellulose ethers, polyoxazolines, polyvinylacetamides, partially hydrolyzed polyvinyl acetate/vinyl alcohol, polyacrylic acid, polyacrylamide, polyalkylene oxide, sulfonated or phosphated polyesters and polystyrenes, casein, zein, albumin, and the like.

U.S. Pat. No. 4,478,910 which is incorporated by reference herein discloses a coating layer comprising a water-soluble polymeric binder and fine silica particles. Polyvinyl alcohol or its derivatives is the particularly preferred water-soluble polymeric binder.

U.S. Pat. No. 4,758,461, incorporated by reference herein, describes a topcoat, which includes a silicon containing type pigment and an aqueous binder. The liquid viscosity of the aqueous coating liquid at 30° C. is in the range of 60 to 200 cps. The aqueous binder is one or more water-soluble polymers such as polyvinyl alcohol, starch, oxidized starch, cationized starch, casein, carboxymethyl cellulose, gelatin, hydroxyethyl cellulose and water-dispersed polymers such as SBR latex, MBR latex, vinyl acetate emulsion. Polyvinyl alcohol is the preferred binder. The ink jet recording medium uses several sizing agents. However, the sizing agents tend to migrate over time in the recording medium, thereby causing changes in the ink absorptivity of the medium and reducing overall print quality of the recorded medium.

U.S. Pat. No. 5,270,103, incorporated by reference herein, describes a coating of a pigment and a binder, which includes polyvinyl alcohol, and one or more additional binder materials. The pigment is a silica, such as a colloidal hydrogel type amorphous silica. Additional binders can be a styrene-butadiene latex, a cationic polyamine, a cationic polyacrylamide, a cationic polyethyleneimine, a styrene-vinyl pyrrolidone copolymer, a styrene-maleic anhydride copolymer, a polyvinyl pyrrolidone, or a vinyl pyrrolidone-vinyl acetate copolymer.

Carbohydrate polymers such as starches and gums can also be used as binders. Examples include cellulose derivatives, chitin, chitosan, dextran, pectin, agar-agar, arrowroot, guar, carrageenan, tragacanth, xanthan, as exemplified by U.S. Pat. Nos. 6,610,136, 6,551,695 and 6,495,243, each of which is incorporated by reference in their entirety herein. Cornstarch is an inexpensive carbohydrate polymer and is one of the lowest binding strength and binding efficiency coating binders that can be used. Some disadvantages of the carbohydrate polymers as binders is that the coating compositions contain low coating solids, poor rheology, and are expensive to manufacture.

Prior topcoat compositions for ink jet printing media have several drawbacks and disadvantages. Problems exist with previous ink jet media topcoats that effect printability and color development.

Previous ink jet media topcoats do not effectively absorb the liquid solvent or carrier component and possess sufficient “hold-out properties” to allow solid pigment or dye to remain concentrated near the coated surface. Ink is often absorbed along the fiber on the media surface resulting in a phenomenon called feathering. Topcoat compositions that possess satisfactory absorbance often produce loss of density and hence, inaccurate color reproducibility in the printer image. A correct balance of the properties is very difficult to achieve especially at higher print resolutions and smaller dot diameters. The result is that in some of the teachings of the prior references, the density, sharpness, and roundness of each dot may still not be sufficient to obtain high quality, high contrast, full color recorded images for ink jet paper.

Another problem is that topcoats that use silica particles often require an excessive amount of binder for processing the solids to achieve the desired minimal coat weight. The suspensions become too viscous to allow pumping and uniform application using conventional coaters such as a blade coater. Attempts to use a lower binder level have resulted in excessive “dusting” in the finished product.

Another problem with previous topcoats is known as cockling in which pulp fibers are swelled with ink resulting in a wavy deformity or “back-through” in which ink reaches the back surface or the paper. Cockling not only impairs image quality but also produces scraping between the recording paper and the printer head.

Thus, there is a need for binders for ink jet printing media topcoats that avoid most, if not all, of the foregoing problems while addressing the unmet needs of the industry. Topcoats that are inexpensive yet produce improved print color (Chroma) development, improved print quality, and possess improved ink absorption/holdout characteristics are needed.

### SUMMARY OF THE INVENTION

The present invention is directed to the use of polydextrose, an indigestible polysaccharide or dextrinized oligosaccharide or a combination thereof as the binder component(s) for an ink jet print receptive topcoat and a filler comprised of silica, which composition exhibits improved ink jet printing printability and improved color development.

It is an object of this invention to provide an ink jet print receptive topcoat composition having good ink drying, ink absorption, and/or water resistance with low wicking and bleeding together with an acceptable dot density, sharpness and roundness, and which is suitable for the recording of high quality, high contrast, full color development.

The foregoing objective is achieved in accordance with the present invention by use of polydextrose, an indigestible polysaccharide or dextrinized oligosaccharide or combination thereof as the binder component of an ink jet media topcoat in combination with a filler comprised of silica.

The present invention also provides compositions and methods for using compositions of a media topcoat which includes a filler comprised of silica, a binder comprised of polydextrose or an indigestible polysaccharide or dextrinized oligosaccharide or combination thereof and a carrier wherein a topcoat derived from the coating composition exhibits a high solids content, low viscosity and when dried is printable with liquid ink jet printing inks.

Other embodiments of the present invention also provide a method for making an ink jet printing medium with a base support layer and an ink receptive topcoat composition wherein the topcoat is printable with liquid ink jet inks and may be readily applied to the base sheet with conventional coating equipment.

The method for making an ink jet printing medium in accordance with the present invention includes the steps of:
preparing a media topcoat comprising a filler comprised of silica, a solvent or carrier and a binder comprised of polydextrose or an indigestible polysaccharide, dextrinized oligosaccharide or a combination thereof;
applying the topcoat composition to at least one side of a substrate; and drying the topcoat on the substrate to produce the ink jet printing medium.

Also contemplated are a printing method and system employing the ink receptive topcoat media.

Still further embodiments of the invention provide printed products of various substrates using the ink receptive topcoat media.

It has surprisingly been found that the use of polydextrose or an indigestible polysaccharide or dextrinized oligosaccharide or combination thereof in a binder in the topcoat for ink jet printing media together with the silica as the filler results in significantly improved print color (Chroma) development, improved print quality through improved ink absorption/holdout characteristics, and lower coating cost when compared to like media employing a coating containing polyvinyl alcohol or polyvinylpyrrolidone as a binder.

Polydextrose as the binder is especially preferred. The effectiveness of using polydextrose as the binder element is based on the 1) function of polydextrose as an effective water-based dye solubilizer and, 2) the pH neutral characteristics of polydextrose acting to minimize dye color shifts resulting in a more pure Chroma value.

### BRIEF DESCRIPTION OF THE DRAWINGS

FIG. 1: depicts the linkage distribution of FIBERSOL-2® versus polydextrose.

FIG. 2: depicts the summary of linkage and branching for FIBERSOL-2® compared to polydextrose.

### DETAILED DESCRIPTION OF THE INVENTION

The print-receptive topcoat for ink jet printing media of the present invention comprises a filler comprised of silica, a binder comprised of polydextrose or an indigestible polysaccharide or dextrinized oligosaccharide or combination thereof, and a carrier.

The print receptive topcoat of the present invention absorbs the liquid component of the ink better than previous media, and provides a quicker ink drying time, while preventing bleeding or diffusion of the ink into the substrate media. Additionally, the topcoat causes the ink pigment to be fixed on the media in the form of well-defined dots of uniform size and shape. Moreover, the topcoat of the present invention features superior color depth.

Applicants have surprisingly discovered that ink receptive coating formulations employing polydextrose and/or an indigestible polysaccharide, or dextrinized oligosaccharide or combination thereof as a binder could be produced at high solids levels resulting in relatively low viscosities, enabling a broader range of coating technology methods used in the actual topcoat deposition to an ink jet media substrate.

The low viscosity facilitates pumping, prevents clogging of the applicator nozzle. Low viscosity facilitates uniform application using conventional coaters such as blade coaters.

The term “ink jet printing media” is used interchangeably with “substrate” and refers to materials upon which the ink and topcoat formulation are applied. Any suitable substrate or media can be employed. Examples of suitable ink jet printing media include paper, card stock, metal, wood, plastic, tape, film, or combinations thereof.

Topcoat formulations produced with polydextrose and/or an indigestible polysaccharide, or dextrinized oligosaccharide in combination with silica yield better color development over those containing PVP. A distinct advantage of using polydextrose and/or an indigestible polysaccharide or dextrinized oligosaccharide or combination thereof in ink jet topcoat formulations is the capability of producing high solids/low viscosity formulas with improved color development over PVP based formulations. This advantage allows for the application of the topcoat utilizing a broad range of coating application processes and technologies.

The term “polydextrose” includes polymer products of glucose which are prepared from glucose, maltose, oligomers of glucose or hydrolyzates of starch, which are polymerized by heat treatment in a polycondensation reaction in the presence of an acid e.g. Lewis acid, inorganic or organic acid, including monocarboxylic acid, dicarboxylic acid and polycarboxylic acid, such as, but not limited to the products prepared by the processes described in U.S. Pat. Nos. 2,436,967, 2,719,179, 4,965,354, 3,766,165, 5,051,500, 5,424,418, 5,378,491, 5,645,647 5,773,604, or 6,475,552, all of which are incorporated by reference herein in their entirety.

The term “polydextrose” also includes those polymer products of glucose prepared by the polycondensation of glucose, maltose, oligomers of glucose or starch hydrolyzates described hereinabove in the presence of a sugar alcohol, e.g. polyol, such as in the reactions described in U.S. Pat. No. 3,766,165, which is incorporated by reference herein. Moreover, the term polydextrose includes the glucose polymers, which have been purified by techniques described in the art, including any and all of the following but not limited to:
(a) neutralization of any acid associated therewith by base addition thereto, or by passing a concentrated aqueous solution of the polydextrose through an adsorbent resin, a weakly basic ion exchange resin, a type II strongly basic ion-exchange resin, mixed bed resin comprising a basic ion exchange resin, or a cation exchange resin, as described in U.S. Pat. Nos. 5,667,593 and 5,645,647, each of which is incorporated by reference herein; or
(b) decolorizing by contacting the polydextrose with activated carbon or charcoal, by slurrying or by passing the solution through a bed of solid adsorbent or by bleaching with sodium chlorite, hydrogen peroxide and the like;
(c) molecular sieving methods, like ultrafiltration, RO (reverse osmosis), size exclusion, and the like;
(d) or enzymatically treated polydextrose or,
(e) any other recognized techniques known in the art.

Moreover, the term polydextrose includes hydrogenated polydextrose, which, as used herein, includes hydrogenated or reduced polyglucose products prepared by techniques known to one of ordinary skill in the art. Some of the techniques for preparation are described in U.S. Pat. Nos. 5,601,863, 5,620,871 and 5,424,418, all of which are incorporated by reference herein. The term polydextrose also encompasses fractionated polydextrose that is a conventional, known material and can be produced, for example, by the processes disclosed in U.S. Pat. Nos. 5,424,418 and 4,948,596, which are incorporated by reference herein.

Polydextrose is commercially available from a variety of companies including Danisco Sweeteners, A. E. Staley and Shin Dong Bang (Korea). Purified forms of polydextrose are marketed by Danisco Sweeteners under the name LITESSE® or LITESSE II® and by A. E. Staley under the name STALITE III®. A reduced form of polydextrose is called LITESSE ULTRA®.

In another embodiment, the binder of the invention is an indigestible polysaccharide. A preferred example of an indigestible polysaccharide is indigestible dextrin(s). Indigestible dextrin is a highly branched polysaccharide derived by pyroconversion from starch. Starch is made of glucose molecules attached by α-(1,4) bonds, with some branching by means of α-(1,6) bonds. The degree of branching is dependent on the source of the starch.

The indigestible dextrin is produced from starch in a heat treatment process known as pyroconversion. Pyrodextrins are starch hydrolysis products obtained in a dry roasting process either using starch alone or with trace levels of acid catalyst. The first product formed in this reaction is soluble starch, which in turn hydrolyzes further to form dextrins. The molecular weight of the final product depends on the temperature and duration of heating. Transglucosidation can occur in the dextrinization process, in which rupture of an α-(1,4) glucosidic bond is immediately followed by combination of the resultant fragments with neighboring hydroxyl groups to produce new linkages and branched structures. Thus, a portion of the glycosidic bonds are scrambled. A commercially available pyroconverted starch is called FIBERSOL-2® and is available from Matsutani America, Inc.

Another preferred indigestible polysaccharide includes the indigestible polysaccharide described in U.S. Pat. No. 5,620,871, the contents of which are incorporated by reference.

U.S. Pat. No. 5,620,871 discloses a method for preparing indigestible polysaccharides by carrying out an enzymatic hydrolysis of a dextrin or polysaccharide using at least one saccharifying enzyme and at least one enzyme which hydrolyzes the 1-6 bonds of amylopectin.

Another preferred example of an indigestible polysaccharide is described in JP Patent Publication No. 2001/086946, the contents of which are incorporated by reference. It describes a hydrogenated starch hydrolysate containing non-digestible polysaccharides which are obtained by hydrolyzing starch with β-amylase followed by hydrogenation of the thus treated dextrin.

A further preferred example of an indigestible polysaccharide is described in JP 62-091501, the contents of which are incorporated by reference. It discloses an indigestible polysaccharide prepared by hydrogenating a starch hydrolyzate obtained from acid or enzyme saccharification of starch, e.g., reduced branched dextrin, in the presence of an acid catalyst, e.g., 0.3-0.5 wt % inorganic acid (e.g., phosphoric acid) or 5-20 wt % organic acid, (e.g., citric acid,) to produce a reduced starch hydrolyzate, which is then dried by heating to 130° C. in a vacuum. The dried product is then heated to 150° C.-250° C. for 1-3 hours to obtain a powdered indigestible polysaccharide comprising an aggregate of a non-reducing polymer of various degrees of polymerization, formed by rearrangement of the glucose residue of the non-reducing sugar mainly at the 1-6 linkage.

The dextrinized oligosaccharide, as used herein, is a saccharide-derivatized oligosaccharide which is described in U.S. Patent Application Publication No. U.S. 2004/0053866, the contents of which are incorporated by reference. It is a saccharide-derivatized mixture comprising the extrusion reaction product of a saccharide product having an average degree of polymerization ranging from 1 to 4 with a mixture of malto-oligosaccharide. As used herein a malto-oligosaccharide is a species comprising two or more saccharide units linked predominantly via 1-4 linkages. It is preferred that the maltooligosaccharide used is maltodextrin.

The preferred binders are indigestible dextrin and especially polydextrose.

In an embodiment of the present invention, the polydextrose in whatever form as well as the indigestible polysaccharides utilized is substantially pure. It is preferred that they are substantially free of impurities. They are preferably at least about 80% pure and more preferably at least about 85% pure and most preferably at least about 90% pure.

The binder, e.g., the polydextrose and the indigestible polysaccharide or the dextrinized oligosaccharide can be purified using techniques known in the art. For example, among the purification processes used in the art, the following are preferred processes for purifying polydextrose: 1) bleaching, e.g. using hydrogen peroxide (described in U.S. Pat. No. 4,622,233); 2) membrane technology (described in U.S. Pat. No. 4,956,458); 3) ion exchange e.g. removal of citric acid (described in U.S. Pat. No. 5,645,647) or removal of color/bitter taste (described in U.S. Pat. No. 5,091,015); 4) chromatographic separation, with a strong cation exchanger (described in WO92/12179); 5) hydrogenation, in combination with ion exchange (described in U.S. Pat. Nos. 5,601,863 and 5,573,794) or 6) with ion exchange and chromatographic separation (described in U.S. Pat. No. 5,424,418); or 7) solvent extraction (described in U.S. Pat. No. 4,948,596 and EP 289 461), the contents of each of these patents being incorporated by reference herein.

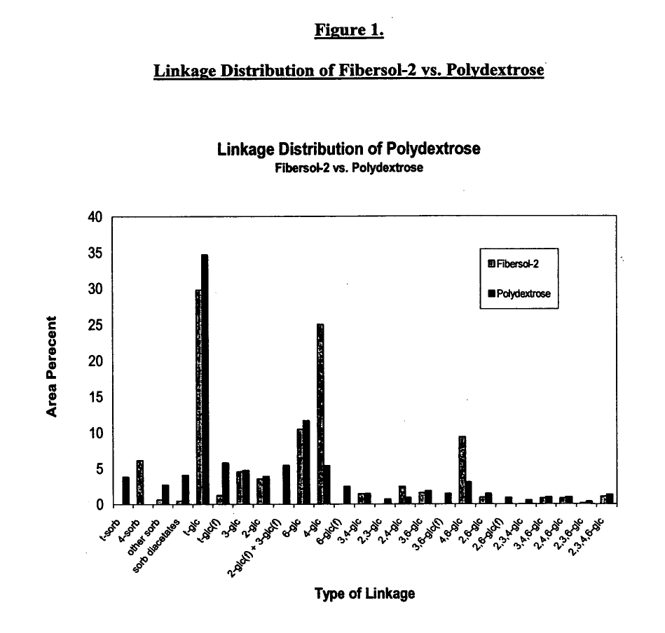

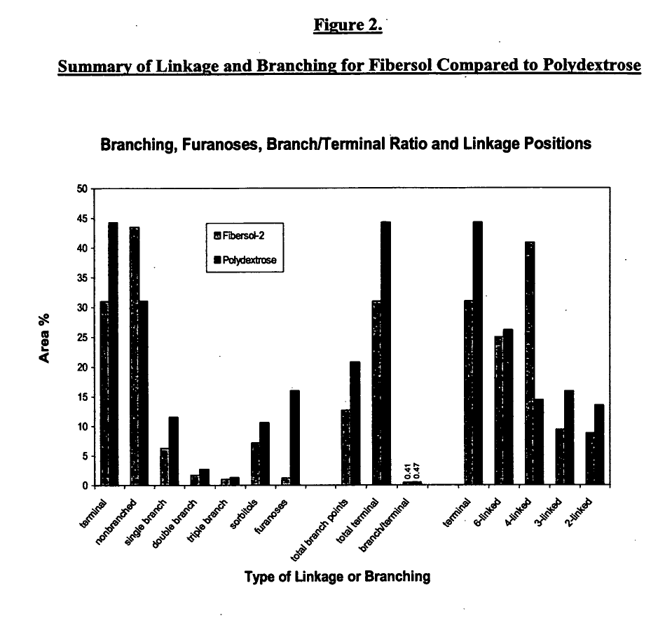

FIGS. 1 and 2 show the summary of linkages and branching in FIBERSOL-2® and polydextrose. The FIBERSOL-2® compared to polydextrose has higher amounts of unbranched and single branched residues, lower content of furanoses and greater amounts of 4- and 4,x-linked residues. Polydextrose, in which 6-linkages predominate, is more highly branched than FIBERSOL-2® and FIBERSOL-2® contains far more 4-linkages, in keeping with its starch origin. Despite these differences, polydextrose and FIBERSOL-2® are very closely related in structure and either can be used alone or in combination in the binder of the present topcoat composition.

The polydextrose or derivatives thereof, e.g. LITESSE® or LITESSE II®, act as a binder. LITESSE II® is preferred because of low costs. Likewise, the indigestible dextrin or derivatives thereof, e.g. FIBERSOL-2®, acts as a binder. The polydextrose or the indigestible polysaccharide, or the dextrinized oligosaccharide e.g., in the “binder” improves the film forming capability of the coating. Without wishing to be bound it is believed that its hydrophilic nature thereof facilitates the absorption of the ink jet ink by the coating during the ink jet printing process.

The binder of the present invention comprised of polydextrose, indigestible polysaccharide, dextrinized oligosaccharide or combination thereof is present in amounts effective to enhance ink jet printability and improve color development. It is preferred that the binder, i.e., polydextrose or indigestible polysaccharide or dextrinized oligosaccharide is present in the range from about 5% to about 93% on a parts by solid weight basis. The preferred concentration of the polydextrose and/or indigestible polysaccharide binder is about 50% to about 70% on a parts by solid weight basis.

Optionally, other binders can be combined with the binders discussed above. Suitable binders include, but are not limited to, other carbohydrate polymers such as starches and gums, other polysaccharides or oligosaccharides, cellulose derivatives, chitin, chitosan, dextran, pectin, agar-agar, arrowroot, guar, carrageenan, tragacanth, xanthan, gelatin, polyvinylpyrrolidone and copolymers thereof, and/or hydrophilic polymers such as polyvinyl alcohol (PVOH), polyvinyl pyrrolidone, gelatin, cellulose ethers, polyoxazolines, polyvinylacetamides, partially hydrolyzed polyvinyl acetate/vinyl alcohol, polyacrylic acid), polyacrylamide, polyalkylene oxide, sulfonated or phosphated polyesters and polystyrenes, casein, zein, albumin, and the like. An example of a binder suitable for the present invention which may be added is Celvol 08-125 poly(vinyl alcohol) binder.

The term “polysaccharide” as used herein is defined as a sugar polymer. Oligosaccharides are defined as sugar polymers with 2-10 residues. Oligosaccharides and polysaccharides as defined herein may be homo- or heterosaccharides. Homosaccharides are based essentially upon a single sugar, e.g. glucooligosaccharides or fructooligosaccharides, and may contain a single linkage type such as maltooligosaccharides (α-1,4-linkages) or a mixture of linkages, e.g., isomaltooligosaccharides (α-1,4-and α-1,6-linkages). Heterosaccharides contain more than a single sugar residue, e.g., arabinogalactan (arabinose and galactose). As defined herein the polymers may be linear or branched.

Suitable oligosaccharides and/or polysaccharides which may be combined with the binder used in the present invention include, but are not limited to, maltooligosaccharides (maltodextrin), isomaltooligosaccharides, cyclodextrins, gentiooligosaccharides, nigerooligosaccharides, fructooligosaccharides, inulin, galactooligosaccharides, xylooligosaccharides, agarooligosaccharides, mannooligosacchradies, chitin/chitosan oligosaccharides, arbinogalactan and pullulan.

In one embodiment of the invention, a topcoat is provided that is comprised of a mixture of a silica filler, and the binder is comprised of polydextrose or indigestible polysaccharide, e.g., indigestible dextrin, or dextrinized oligosaccharide or a combination thereof. The components can be dissolved, or dispersed into a solvent solution or carrier comprised of deionized water, a suitable alcohol or a combination of the two. Other components can be added to improve coating wet out (or spread) of the coating during application to the ink jet media base support layer, improve the pot life or working time of the coating during application, impart other properties to the coating or to modify the viscosity or solids content of the coating and/or act as a biocide agent.

Drying and surface holdout of the printed inks on the topcoat are facilitated by the addition of a pigment or filler. The pigment or filler not only aids in surface holdout of the ink but also introduces pores or channels to the topcoat to aid in drying. The filler, i.e., silica, content of the invention results in the ink absorptive nature of the coating and is partially responsible for the permanent nature of the adhesion of the ink to the coated media base. The binder of the present invention, e.g., polydextrose, aids in binding of the silica to the paper substrate. The preferred filler is silica. A variety of silica types are well known, available, and suitable for use such as fumed silica, precipitated silica, and silica gel. Silica types exhibit different pore sizes resulting in varying degrees of ink absorbing capabilities. A fumed silica gel dispersion particularly suitable for the present invention is CAB-O-SPERSE PG001 (produced by the Cabot Corporation), which possesses high pore volume and ready dispersion into the solvent solution.

Concentration of the silica filler component can range from about 0% to about 90% on a parts by weight basis and are covered under this invention. The preferred concentration of the silica gel filler is from about 25% to about 50%.

It is understood that other fillers may be used together with the silica, including, but not limited to calcium carbonate, kaolin, and mixtures thereof.

Other ingredients or additives may be added to avoid problems which occur during mixing and application such as improper wetting of the substrate surface, foaming of the composition when exposed to high mixing rates, adhesion of the dry composition to the substrate, and preservation of the components from biological attack (e.g. fungi). For example, non-ionic surfactants, defoamers or preservatives may be added. An example of a defoamer suitable for the present invention is FOAMASTER 111 silicone based defoamer. An example of a suitable preservative for the present invention is PROXEL GXL.

Further, the ink jet printing media topcoat of the present invention can contain an additive such as a biocide, an anti-curling agent or anti-blocking agent. The topcoat can also contain other additives known to those skilled in the art to improve the print image, such as, but not limited to, for example, UV absorbers, optical brighteners, light stabilizers, antioxidants, humefactants, spacing agents, plasticizers, dye mordants, fixatives, dispersants, rheology modifiers, leveling agents and the like.

In a preferred embodiment, the ink jet topcoat also includes a surfactant to charge the pigment. Preferred surfactants are nonionic. However, cationically or anionically charged surfactants can also be used. An example of a suitable surfactant includes, but is not limited to, polyethylene glycol (TRITON X-100®) (DOW-UCAR). The surfactant is employed at a concentration of about 0.1% to about 5% on a parts by weight basis, and more preferably at about 0.5% to about 2% on a parts by weight basis.

In still another embodiment, the topcoat of the present invention includes a biocide agent. An example of a suitable biocide agent is PROXEL GXL® (1,2-Benzisothiazolin-3-one, produced by Avecia Biocides), with a concentration in a range of about 0% to about 1% on a parts by weight basis.

The topcoat solvent or carrier liquid can be deionized water, monohydric alcohol, polyhydric alcohol or a combination thereof. Preferred is deionized water. Typical concentration of the solvent or carrier liquid can range from about 50% to about 85% on a parts by weight basis. Deionized water is preferably ion-exchanged water of which the Ca⁺² ion and Mg⁺² ion contents have been reduced to not more than about 5 ppm.

The topcoat coating will preferably have a dried thickness of about 0.1 to about 0.5 mils, or from about 2 to about 13 grams/square meter. However, topcoat thickness in a range from about 1 to about 25 grams/square meter or more can be effective. Actual topcoat coating thickness within this range can be variable based on the specific ink jet media base being coated. The invention covers all ranges of dried coating thicknesses as noted.

Method of Preparation

The topcoat of the present invention is formulated by adding the silica filler component to deionized water while mixing under a mild level of agitation until homogeneous. The binder is then added to the deionized water solution and mixed under a mild level of agitation until homogeneous. Mixing is performed with a spindle with multiple blades in an open vessel. The rate of mixing is that which results in a homogeneous mixture without inducing foaming. The addition of other components, as noted earlier, including surfactants, biocides, and the like, are added in succeeding steps as required to improve the coatability, or extend the pot life/stability of the coating.

The order of adding additives is based on ingredient functionality. For example, the defoamer is added to deionized water prior to the addition of the polydextrose, indigestible polysaccharide, dextrinized oligosaccharide or combination thereof and, optionally, additional binders to inhibit the foaming from the addition of those ingredients. Cationic mordants such as Ageflex™ are added subsequent to the silica filler to inhibit flocculation of the silica particles.

The total solids content of the compounded ink jet topcoat composition can range from about 10% to about 50% on a parts by weight basis. The viscosity of the compounded topcoat can range from about 10 to about 20 cps (centipoise). Both the solids content and the viscosity of the compounded topcoat can be varied or adjusted based on actual coating requirements dictated by the method of applying the topcoat composition to the ink jet media base layer that is to be coated.

The invention can be applied, or coated onto an ink jet media base support layer using a variety of commonly known coating techniques. The ink jet media, or base support layer, can be an uncoated paper, a coated paper (coated on one side or two sides), a polymer film, a laminate of paper and film or other suitable material useful in ink jet printing. Preferred substrates are paper and paper type media.

Any application method known to those skilled in the art can be employed to apply the ink jet topcoat to the ink jet media base. Topcoat application techniques that can be used include, but are not limited to, wire wound rod, metering bar, knife over roll, direct gravure, reverse gravure, reverse roll and multiple roll methods, and air knife. These coating methods can be employed as a secondary process to apply, or coat the topcoat composition onto an ink jet media base after manufacturing of the media base.

The ink jet topcoat of the present invention can also be applied to a paper ink jet media base in a size press during the media manufacturing process of a base paper. In addition, the ink jet topcoat of the present invention can be applied to the ink jet media base during a secondary printing, or converting operation, during which the ink jet media can undergo actual printing and die-cutting operations after application of the topcoat as in the case of labels. The ink jet topcoat would then be applied prior to the printing, and die cutting operations.

It is understood that the topcoat of the present invention can be applied to one or both sides of the media substrate. Additionally, other coats such as anti-curl coats can be applied.

After application of the ink jet topcoat to, and absorption by, the ink jet media base layer the ink jet topcoat is dried to drive off the solvent carrier liquid from the topcoat composition. The drying process can be accomplished through the use of any drying method known to those skilled in the art. Preferred are evaporative drying processes. Drying processes that can be used in the present invention include, but are not limited to, air drying, convection, radio frequency, or infrared methods.

Noting that to date, no unifying theory that explains molecular interactions which take place between the ink jet medium topcoat and the medium itself, the present invention should not be limited to a particular theory of operation. In general, to obtain an image of high chroma, it is believed, without wishing to be bound, that the ink jet printing ink (dye or pigment based) coloring material should be retained on the surface of a recording medium in a monomolecular state without aggregation. When aggregation of the ink jet printing ink material on the surface of the recording medium occurs, Chroma can be lowered. The superior color development of the compositions of the invention results from the presence of the binder, e.g., specific range of linear and branched oligomers, and low to high molecular weight range (DP distribution) in polydextrose or FIBERSOL-2® combined with its highly amorphous nature which inhibits aggregation of the coloring material.

The most preferred binder is polydextrose. When polydextrose was used as the binder in topcoat compositions, prepared in accordance with the present invention, formulation evaluations showed polydextrose to function as an effective binder for paper ink jet media coatings. Without wishing to be bound, it is believed that polydextrose is preferred due to its natural affinity for paper and its effectiveness in solubilizing water-based dyes. A preferred ink receptive coating is formulated containing polydextrose.

In another embodiment, black pigment ink hold out on the printed surface was optimized via modification of the coating formulation with cationic dye mordant and use of polyvinyl alcohol (PVOH) as a co-binder.

Paper samples coated with an optimized formulation containing the binder utilized in the present invention, e.g., polydextrose or indigestible polysaccharide or dextrinized oligosaccharide or combination thereof in combination with the filler comprised of silica, e.g., showed improved physical properties when compared with commercially available topcoated ink jet printing papers. Physical properties include, but are not limited to, curl (ASTM D 4825), blocking (ASTM D 918), and smoothness (TAPPI T-538). The ink receptive layer can absorb water in the air and swell in an environment of high relative humidity, causing curling. Sheffield smoothness is a measurement of pressurized air flow over the surface under prescribed conditions.

Paper samples coated with the composition of the present invention containing polydextrose and/or indigestible polysaccharide or dextrinized oligosaccharide or combination thereof and as the binder and a filler comprised of silica showed improved printing quality in most aspects. Print quality assessments include curl, feathering, mottling, wet or dry cockle, image bleed, banding, bronzing, skew or artifacts. Feathering is a phenomenon that is evidenced primarily in printed text and is caused by ink flowing along fibers in the paper. Visual evidence of feathering is small protrusions around the edges of a printed image. Mottling is defined as printing defects resulting in non-uniform print density of a solid filled area. Coalescence is defined as printing defects caused by pooling of ink in areas on the surface of the paper. Wet cockle is evidenced by wave patterns during application of wet ink to the paper surface. Dry cockle is the result of non-uniform print densities arising from wet cockle. Image bleed can be visually evidenced by the mixing of one ink color with another adjacent ink color. Bleed is usually a result of severe feathering. Banding is evidenced by regions of bands of varying print density in a solid filled area. Bronzing is the appearance of a bronze sheen to solid filled black print areas. Skew relates to the position of printed images to the border of the paper. Artifacts include any droplets or ink spray located in unprinted areas of the paper. Issues relating to mottling/coalescence and wet/dry cockle are likely due to the coating techniques used.

The use of the composition of the present invention provided enhanced print quality, decreasing the amount of and more preferably minimizing the amount of curl, feathering, mottling, cockling, bleeding, banding, bronzing, and the presence of artifacts relative to a composition in which the silica and binder, e.g., polydextrose, or indigestible polysaccharide or dextrinized oligosaccharide or combination thereof, are not present.

The overall print quality of paper coated with the binder of the present invention was compared to that of commercial ink jet printable paper and showed the following advantages: (1) improved printability; (2) improved printed color purity (Chroma) for dye-based inks; and (3) comparable-to-improved physical properties over commercially available ink jet printable papers.

Commercially available ink jet products provide examples of suitable ink jet printing media which the print receptive topcoat of the present invention can be applied to. It is understood that the media can be paper, card, stock, metal, wood, plastic, or film.

As used herein, unless indicated to the contrary, the plural denotes the singular and vice versa.

By percent on a weight basis as used herein is meant percentages in the composition which includes the liquid carrier component.

The following examples serve to provide further appreciation of the invention but are not meant in any way to restrict the effective scope of the invention.

While not wishing to be limited to a particular theory of operation, for purposes of the experimental coating of materials, a conventional laboratory drawdown coating device employing a wire-wound rod to apply and meter the coating was employed.

### EXAMPLE 1

An ink jet receptive top coating for paper was formulated as set forth in Table 1. Polydextrose was formulated with the nonionic surfactant polyethylene glycol (TRITON®) (Dow), fumed silica (CAB-O-SIL®) (Cabot Corporation), and a biocide (PROXEL GXL®) (1,2-Benzisothiazolin-3-one, Avecia Biocides).

TABLE 1

| | |
|---|---|
| Polydextrose | 10.0% |
| Cab-O-Sil S-610 ® | 5.0% |
| Triton X-100 ® | 1.0% |
| Proxel GXL ® | 0.1% |
| Deionized water | 83.9% |

Mixing of the formula components was conducted with a Caframo RZR 1 electric mixer operating at medium to low shear agitation. Mixing was continued until visual homogeneity was obtained without any foaming. The formulation was then flood-coated onto a 60 lb/ream offset opaque paper. Examples of opaque paper include HuSky Offset (manufactured by Weyerhaeuser) and Pristine Opaque (manufactured by Eastern Paper) Using a meyer rod (wire wound rod) employing a ChemInstruments EZ-2002 laboratory coater the coating was applied to the substrate to achieve target coating weights from about 2 grams to about 6 grams per square meter range.

Initial ink jet printing was performed using an HP DeskJet 6122 printer with dye-based color ink (HP C6578DN) and pigment-based black ink (HP 51645A). The pattern chosen included blocks of the following colors: cyan, magenta, yellow, black, red, orange, blue, and green. Printed samples showed good visual color development over the uncoated base paper printed in a similar manner.

### EXAMPLE 2

Modifications to optimize the ratio of polydextrose and silica as well as the final coating solids were undertaken. A silica dispersion (CAB-O-SPERCE PG001®) (Cabot Corporation) was used in place of CAB-O-SIL® filmed silica to aid in ease of formulation. Eight formulations (B through I) as set forth below in Table 2 were prepared with varying polydextrose to silica ratios while holding other ingredients constant.

TABLE 2
Formulations B through I

| | B | C | D | E | F | G | H | I |
|---|---|---|---|---|---|---|---|---|
| Polydextrose | 1 | 1 | 1 | 1 | 2 | 4 | 9 | 1 |
| Cab-O-Sperce ® | 18 | 5 | 3 | 1 | 1 | 1 | 1 | 0 |
| PG001 | | | | | | | | |

The percentage of overall solid material in the formulations was kept constant. Little to no change in viscosity was seen with the addition of more polydextrose.

Visual investigations of printed dye-based color inks and pigment-based black ink were made. Subjects rankings were assigned based on the visual appearance of printed samples. Printed samples were ranked from best (1) to worst (8) in appearance. Rankings are listed in Table 3.

TABLE 3
Rankings from Visual Inspection of Printed Samples

| | B | C | D | E | F | G | H | I |
|---|---|---|---|---|---|---|---|---|
| dye-based | 8 | 4 | 2 | 2 | 1 | 5 | 6 | 7 |
| color inks | | | | | | | | |
| pigment | 8 | 7 | 6 | 4 | 4 | 2 | 2 | 1 |
| black ink | | | | | | | | |
| overall | 8 | 7 | 4 | 2 | 1 | 3 | 4 | 4 |
| rank | | | | | | | | |

An apparent “optimum state” was observed wherein the addition of additional polydextrose does not visually improve dye-based color ink appearance. However, the combining of additional amounts of polydextrose improved the overall appearance of printed pigment-based black ink. Formulation F resulted in the best overall coating for visual appearance of dye-based color ink and pigment-based black ink.

### EXAMPLE 3

Variations in the solid levels of Formulation F and the effect on viscosity are found in Table 4.

TABLE 4
Solids Versus Viscosity

| | F | F-1 | F-2 | F-3 | F-4 |
|---|---|---|---|---|---|
| solids level | 16% | 20% | 25% | 30% | 35% |
| viscosity | 12.0 | 14.5 | 18.0 | 22.5 | 30.0 |
| (cPs) | | | | | |

Viscosity has a potentially large effect on determination of application method of a coating to paper. Increasing the solids content in formulations with polydextrose caused only a slight increase in viscosity. This indicates that a broad range of coating application technologies and methods are potentially suitable for the deposition of a polydextrose-based binder topcoat to the ink jet media base.

### EXAMPLE 4

The performance of polydextrose as an ink receptive coating component was compared to patented formulations for ink jet receptive top coatings employing poly(vinyl alcohol) (PVOH) and/or poly(vinyl pyrrolidone) (PVP) for viscosity and visual appearance with printed dye-based color inks and pigment-based black ink. The patent formulations used for comparison, i.e., WO 95/06564, U.S. Pat. No. 4,775,594 and WO 02/43965 are found in Tables 5-7 below, respectively. Table 8 lists rankings from visual inspection of the printed samples. Table 9 provides comparisons of viscosity.

TABLE 5
Patent Formulation PVOH I (WO 95/0654)

| | |
|---|---|
| Celvol 125^{†} ® | 9.0% |
| Cab-O-Sperse PG001 ® | 0.2% |
| K-90 (PVP)^{††} ® | 1.0% |
| deionized water | 89.8% |

^{†}available from Celanese Chemicals
^{††}available from ISP Techologies

TABLE 6
Patent Formulation PVP I (U.S. Pat. No. 4775594)

| | |
|---|---|
| Dowanol PM ®* | 43.3% |
| Zonyl FSJ^{?} ® ^{a} | 0.5% |

††: available from ISP Techologies
†††: available from
*available from Aldrich
^{a}available from DuPont

TABLE 7
Patent Formulation PVP II (WO 02/43965)

| | |
|---|---|
| K-90 (PVP) ®^{††} | 9.1% |
| Syloid 620 ®** | 3.9% |
| n-butanol | 43.3% |

^{††}available from ISP Techologies
**available from Grace Davison

Coatings were produced on 60 lb/ream offset opaque base paper at similar coating weights. A visual comparative ranking of the appearance of the printed inks was made of the patent formulations and Formulation F as described in Table 8.

TABLE 8
Rankings from Visual Inspection of Printed Samples

| | F | PVOH I | PVP I | PVP II |
|---|---|---|---|---|
| dye-based | 1 | 2 | 3 | 4 |
| color inks | | | | |
| pigment | 4 | 1 | 3 | 2 |
| black ink | | | | |
| overall | 2 | 1 | 3 | 3 |
| rank | | | | |

Formulation F coating overall exhibited improved (the best) dye-based color ink appearance as well as inferior pigment-black ink appearance when compared to the patent formulations. The visual appearance of printed samples was slightly better than formulations based on PVP alone, however, the visual appearance was not comparable to printed sample with PVOH and PVP co-binders in the top coating.

TABLE 9
Viscosity Comparison Table

| | F | PVOH I | PVP I | PVP II |
|---|---|---|---|---|
| solids | 16.0% | 10.0% | 13.1% | 10.0% |
| viscosity | 12 | 1631 | 1387 | 593 |
| (cPs) | | | | |

Formulation F, at slightly higher solids than the three patent formulations, exhibited the lowest viscosity. Formulations involving PVOH or PVP are well known for exhibiting viscosity increases with increasing solids levels. Formulations with polydextrose do not exhibit this trend.

### EXAMPLE 5

Additional modifications were made to optimize Formulation F to aid in pigment-based black ink appearance. Visual inspection of the printed pigment-black areas indicated a less than desirable level of hold out of the pigment on the surface of the coated paper. To improve the black pigment ink holdout, the following modifications were made: (1) crosslinking of the polydextrose, (2) addition of cationic dye mordants, and (3) use of co-binders.

Polydextrose contains high concentrations of free hydroxyl groups that can potentially be used in crosslinking polymer chains. Titanates, an example being TYZOR® product line (DuPont) and isocyanates, an example being DESMODUR® (Bayer) are widely known and used for crosslinking of hydroxyl chemistries. Various crosslinkers were evaluated with Formulation F at concentrations known to those in the art. Evaluation of thermally crosslinked coatings shows no visual improvement of the pigment-based black ink hold out on the surface.

Cationic mordants are well known in the ink jet receptive coating industry for use in anchorage of anionic dye-based inks (U.S. Pat. Nos. 4,554,181, 5,474,843, 5,747,148, 5,795,425 and 5,908,723). Examples of cationic mordants are AGEFLEX® products (Ciba Specialty Chemicals). For example, Ageflex FA 1q75MC is N,N-Dimethylaminoethyl Methacrylate Methyl Chloride Quaternary. These chemicals are also known to have flocculation properties when used in the paper processing industry. Use of cationic mordants can be mutually beneficial for anchorage of anionic dye-based inks to the paper base along with potential flocculation of the pigment present in the black ink to aid in surface hold out. Formulations produced with various mordants result in improvements in pigment hold out on the surface.

Issues with pigment anchorage to the surface of the paper were seen with formulations containing mordants. A small percentage of PVOH was added as a co-binder to aid in overall anchorage of the ink to the paper substrate. The resulting optimized Formulation J, depicted in Table 10 exhibited improved pigment-black ink hold out without diminishing the visual integrity of the dye-based inks.

TABLE 10
Formulation J

| | |
|---|---|
| Polydextrose | 9.1% |
| Triton X-100 ® | 1.2% |
| Cab-O-Sperce PG001 ® | 18.2% |
| Proxel GXL ® | 0.2% |
| deionized water | 63.1% |
| Ageflex FA1Q75MC ® | 4.8% |
| Celvol 125 ®^{†} | 3.0% |
| Foamaster 111 ®*** | 0.4% |

^{†}available from Celanese
***available from Cognis

Physical and optical properties were assessed on paper coated with Formulation J alongside two commercially available ink jet printable papers (Great White 86000 Ink Jet and Hewlett-Packard HPK115R Color Ink Jet papers). Curl (ASTM D 4825), blocking (ASTM D 918), and smoothness (TAPPI T-538) were evaluated on the three papers. Results are listed in Table 11.

TABLE 11
Physical Property Assessment

| | | Great | |
|---|---|---|---|
| | J | White | HP Color |
| Curl (mm) | 6 | 8 | 4 |
| Blocking | none | none | none |
| Sheffield | 136 | 124 | 109 |
| Smoothness (cc/min) | | | |

The ink receptive layer can absorb water in the air and swell in an environment of high relative humidity, causing curling. For the present invention, curl was seen to be in the machine direction of the paper in all cases. None of the three papers studied exhibited any inter-sheet adhesion (i.e. blocking) when tested under 0.5 pounds per square inch at 140° F., 75% relative humidity for 21 hours. Sheffield smoothness is a measurement of pressurized air flow over the surface under prescribed conditions. Overall results were comparable between the three papers with the exception of the smoothness of the sample coated with Formula J which can be expected to yield an improved ink jet printed image. Paper samples coated with Formula J showed comparable-to-improved physical properties when compared with commercially available topcoated ink jet printing papers.

Print quality assessments of the three papers were made based on ASTM F 1944. Feathering, mottling/coalescence, wet/dry cockle, and image bleed were comparatively evaluated. Results are presented in Table 12.

Rankings were assigned to each property based on severity. A ranking of 1 correlates to the effect not evidenced or low severity whereas a ranking of 3 correlates to severe visual evidence of the effect. A more detailed effect-by-effect assignment of rankings can be found in the ASTM F 1944 procedure.

TABLE 12
Print Quality Assessment Rankings

| | | Great | |
|---|---|---|---|
| | J | White | HP Color |
| feathering | 2 | 2 | 2 |
| mottling/coalescence | 3 | 1 | 2 |
| wet/dry cockle | 3 | 1 | 2 |
| image bleed | 2 | 1 | 1 |
| banding | 1 | 2 | 2 |
| bronzing | 3 | 1 | 1 |
| skew | 1 | 1 | 1 |
| artifacts | 1 | 1 | 1 |
| overall rank | 2 | 1 | 2 |

Assessments made from laboratory produced material can not correlate well with precision manufactured ink jet coated papers such as the Great White and HP papers. By their very nature laboratory applied coatings exhibit lesser levels of coating consistency than commercially coated papers. Issues deemed severe such as mottling/coalescence and wet/dry cockle as noted in the results would be improved by more precise and controlled coating of Formulation J to a base paper.

Print quality assessment testing of paper coated with Formulation J showed issues relating to mottling/coalescence and wet/dry cockle that are likely due to coating technique.

Commercial, production scale application of Formulation J would eliminate these issues.

Optical testing of printed Formulation J coated paper shows improved chroma values for all colors evaluated with two different types of dye-based ink. To measure the effect of polydextrose on the ink color development, chroma evaluations were performed on the various colors printed on the three papers. Chroma is generally referred to as color purity. Higher chroma values correlate to higher purity in color, a richer or denser color rendition. The three papers were printed with the HP DeskJet 6122 printer as aforementioned and chroma evaluated. Results are found in Table 13.

TABLE 13
Chroma Data for Various Printed Colors

| | | Great | |
|---|---|---|---|
| | J | White | HP Color |
| RED | 54.24 | 41.15 | 44.30 |
| CYAN | 55.27 | 46.11 | 47.41 |
| BLACK | 2.50 | 0.86 | 1.48 |
| ORANGE | 54.81 | 41.17 | 43.58 |
| BLUE | 45.12 | 33.98 | 35.68 |
| MAGENTA | 60.80 | 49.59 | 51.53 |
| YELLOW | 79.52 | 65.57 | 66.79 |
| GREEN | 59.83 | 46.61 | 48.17 |

Chroma measurements were highest for all colors with Formulation J coated paper. This is directly related to polydextrose presence in the formulation. To verify these results, an Epson Color Stylus C44UX printer was used to print the same test pattern. All inks used in the C44UX printer are purely dye-based. Results are found in Table 14.

TABLE 14
Chroma Data from Epson Printer

| | | Great | |
|---|---|---|---|
| | J | White | HP Color |
| RED | 52.06 | 48.95 | 49.40 |
| CYAN | 32.84 | 33.73 | 36.19 |
| BLACK | 2.98 | 2.68 | 2.58 |
| ORANGE | 54.38 | 48.76 | 50.28 |
| BLUE | 44.28 | 36.26 | 37.42 |
| MAGENTA | 62.04 | 54.88 | 55.52 |
| YELLOW | 66.71 | 56.34 | 57.42 |
| GREEN | 56.93 | 41.84 | 43.27 |

The values obtained confirmed the trend of higher chroma with a topcoat incorporating polydextrose as a binder. Chroma values for the test prints ranged from comparable to significantly improved versus those seen with the two standard commercially available ink jet papers.

While certain preferred and alternative embodiments of the invention have been set forth for purposes of disclosing the invention, modification to the disclosed embodiments can occur to those who are skilled in the art. Accordingly, the appended claims are intended to cover all embodiments of the invention and modifications thereof, which do not depart from the spirit and scope of the invention.

What is claimed:

1. An ink receptive media topcoat for ink-jet printing media comprising a filler comprised of silica, a carrier liquid and a binder comprised of polydextrose, indigestible polysaccharide, dextrinized oligosaccharide or combination thereof, in an amount effective to enhance ink jet printability or color development relative to an ink receptive media topcoat without said binder.

2. The ink receptive media topcoat for ink jet print media of claim 1 wherein said topcoat comprises between about 5% to about 93% binder on a parts by solid weight basis.

3. The ink receptive media topcoat for ink jet print media of claim 1 wherein said topcoat comprises between about 50% to about 70% binder on a parts by solid weight basis.

4. The ink receptive media topcoat for ink jet printing media of claim 1 further comprising additional binders selected from the group consisting of oligosaccharides, maltooligosaccharides, isomaltooligosaccharides, cyclodextrins, gentiooligosaccharides, nigerooligosaccharides, fructooligosaccharides, inulin, galactooligosaccharides, xylooligosaccharides, agarooligosaccharides, mannooligosacchradies, chitin/chitosan oligosaccharides, arbinogalactan, pullulan, derivatives thereof, and combinations thereof.

5. The ink receptive media topcoat for ink jet printing media of claim 1 wherein said filler is selected from the group consisting of silica, fumed silica, precipitated silica, or silica gel, or mixture thereof.

6. The ink receptive media topcoat for ink jet printing media of claim 1 wherein said filler additionally comprises calcium carbonate or kaolin.

7. The ink receptive media topcoat for ink jet printing media of claim 1 wherein said silica is present in the topcoat in a concentration from about 25% to about 50% on a parts by weight basis.

8. The ink receptive media topcoat for ink jet printing media of claim 1 wherein said carrier liquid is selected from the group consisting of deionized water, alcohol, and mixtures thereof.

9. The ink receptive media topcoat for ink jet printing media of claim 1 wherein said carrier liquid is deionized water.

10. The ink receptive media topcoat for ink jet printing media of claim 9 wherein said deionized water is present in an amount from about 50% to about 85% on a parts by weight basis.

11. The ink receptive media topcoat for ink jet printing media of claim 1 wherein said topcoat further comprises an additive.

12. The ink receptive media topcoat for ink jet printing media of claim 11 wherein said additive is selected from the group consisting of dye mordants, fixatives, dispersants, optical brighteners, rheology modifiers, leveling agents, defoamers, surfactants, preservatives, biocides, binders, UV absorbers, optical brighteners, light stabilizers, antioxidants, humefactants, spacing agents, plasticizers, and combinations thereof.

13. The ink receptive media topcoat for ink jet printing media of claim 1 wherein said topcoat further comprises a biocide.

14. The ink receptive media topcoat for ink jet printing media of claim 1 wherein said topcoat further comprises a surfactant.

15. The ink receptive media topcoat for ink jet printing media of claim 14 wherein said surfactant is polyethylene glycol.

16. The ink receptive media topcoat for ink jet printing media of claim 1 further comprising a binder selected from the group consisting of carbohydrate polymers and hydrophilic polymers, copolymers thereof, and combinations thereof.

17. The ink receptive media topcoat for ink jet printing media of claim 16 wherein said carbohydrate polymers are selected from the group consisting of starches and gums, cellulose derivatives, chitin, chitosan, dextran, pectin, agar-agar, arrowroot, guar, carrageenan, tragacanth, xanthan, gelatin, polyvinylpyrrolidone, copolymers thereof, and combinations thereof.

18. The ink receptive media topcoat for ink jet printing media of claim 16 wherein said hydrophilic polymers are selected from the group consisting of polyvinyl alcohol, polyvinyl pyrrolidone, gelatin, cellulose ethers, polyoxazolines, polyvinylacetamides, partially hydrolyzed polyvinyl acetate/vinyl alcohol, polyacrylic acid), polyacrylamide, polyalkylene oxide, sulfonated or phosphated polyesters and polystyrenes, casein, zein, albumin, copolymers thereof, and combinations thereof.

19. The ink receptive media topcoat for ink jet print media of claim 1 wherein said topcoat comprises between about 10% to about 50% total solids on a parts by solid weight basis.

20. The ink receptive media topcoat for ink jet print media of claim 1 wherein said topcoat has a viscosity of about 10 to about 20 cps.

21. The ink receptive media topcoat according to claim 1 wherein the binder is polydextrose or indigestible dextrin or combination thereof.

22. The ink receptive media topcoat according to claim 21 wherein the polydextrose is hydrogenated.

23. A method of making the ink receptive topcoat composition of claim 1 for ink jet printing media comprising the steps of: mixing the binder with the filler component in the carrier liquid until visually homogeneous.

24. The method according to claim 23 wherein additives are added to said composition, said additives being selected from the group consisting of at least one of the following components: dye mordants, fixatives, dispersants, optical brighteners, rheology modifiers, leveling agents, defoamers, UV absorbers, optical brighteners, light stabilizers, antioxidants, humefactants, spacing agents, plasticizers, preservatives, biocides, surfactants, and combinations thereof.

25. A method for making an ink jet printing medium comprising the steps of:
(a) preparing the ink receptive media of said topcoat of claim 1;
(b) applying said topcoat to at least one side of a substrate; and drying the substrate to produce the ink jet printing medium.

26. The method for making an ink jet printing medium as in claim 25, wherein the step of applying the topcoat comprises applying the topcoat to both sides of the substrate.

27. The method for making an ink jet printing medium as in claim 25 comprising applying said topcoat onto an ink jet media base support layer.

28. The method for making an ink jet printing medium of claim 27 wherein said binder is polydextrose.

29. The method for making an ink jet printing medium of claim 27 wherein said binder is indigestible dextrin.

30. The method for making an ink jet printing medium of claim 27, wherein said topcoat is applied to a thickness of about 2 to about 13 grams/square meter.

31. A printed product comprising a substrate and the ink receptive topcoat for ink-jet printing media of claim 1 layered on said substrate, wherein the amount of topcoat thereon ranges from about 1 to about 25 gms/m².

32. The printed product of claim 31 wherein said product is paper, card stock, metal, wood, plastic, tape, film or combinations thereof.

33. A substrate coated on the surface thereof with an ink receptive topcoat of claim 1 or 4.

34. An improved printing medium, wherein the medium has a coating layer thereon, the improvement comprising said coating of said printing medium being comprised of the ink receptive topcoat of claim 1 or 4.

35. The improved printing medium of claim 34, wherein said medium is paper, card stock, metal, wood, plastic, tape, film or combination thereof.
